(19) United States
(12) Patent Application Publication
(10) Pub. No.: US 2013/0167831 A1
(43) Pub. Date: Jul. 4, 2013

(54) THERMAL INSULATOR HAVING INFRARED-REFLECTIVE COATING

(71) Applicants: Bryan William McEnerney, Encino, CA (US); Charles Thomas Kudija, JR., Santa Clarita, CA (US); Andrew J. Zillmer, West Hills, CA (US)

(72) Inventors: Bryan William McEnerney, Encino, CA (US); Charles Thomas Kudija, JR., Santa Clarita, CA (US); Andrew J. Zillmer, West Hills, CA (US)

(21) Appl. No.: 13/342,538

(22) Filed: Jan. 3, 2012

(51) Int. Cl. F24J 2/00; B32B 3/00; B32B 3/02; B32B 15/04

(52) U.S. Cl. 126/569; 428/188; 428/69

(57) ABSTRACT

A thermal insulator includes a plurality of insulation layers with a first insulation layer spaced apart from a second insulation layer such that there is an open gap there between. At least one of the first insulation layer or the second insulation layer includes a substrate and an infrared-reflective coating on the substrate.

### STATEMENT REGARDING FEDERALLY SPONSORED RESEARCH OR DEVELOPMENT

This invention was made with government support under contract number HR0011-07-C-0093 awarded by the United States Department of Defense. The government has certain rights in the invention.

### BACKGROUND

This disclosure relates to thermal systems, and more particularly to a thermal insulator for more efficiently retaining thermal energy within the system.

Thermal systems are known and used to collect thermal energy for conversion into electricity, propulsion, stored thermal energy or other desired use. For instance, solar power systems collect solar energy for conversion into electricity, propulsion or stored thermal energy. Solar trough systems direct solar energy toward a solar receiver to heat a working fluid that is carried through the solar receiver. Similarly, solar thermal propulsion systems direct the solar energy toward a solar receiver to heat a propellant that is carried through the receiver and later expanded to generate propulsion.

### BRIEF DESCRIPTION OF THE DRAWINGS

FIG. 1 schematically illustrates an example thermal insulator.

FIG. 2 shows a portion of a thermal insulator having a first insulation layer and a second insulation layer.

FIG. 3 shows another example thermal insulator having a first insulation layer and a second insulation layer.

FIG. 4 illustrates another example thermal insulator having multiple layers with infrared-reflective coatings.

FIG. 5 shows another example thermal insulator having alternating layers with and without infrared-reflective coatings.

FIG. 6 shows an example solar receiver that utilizes a thermal insulator.

FIG. 7 shows another view of the solar receiver of FIG. 6.

FIG. 8 shows a solar thermal propulsion device that utilizes a thermal insulator.

### DETAILED DESCRIPTION

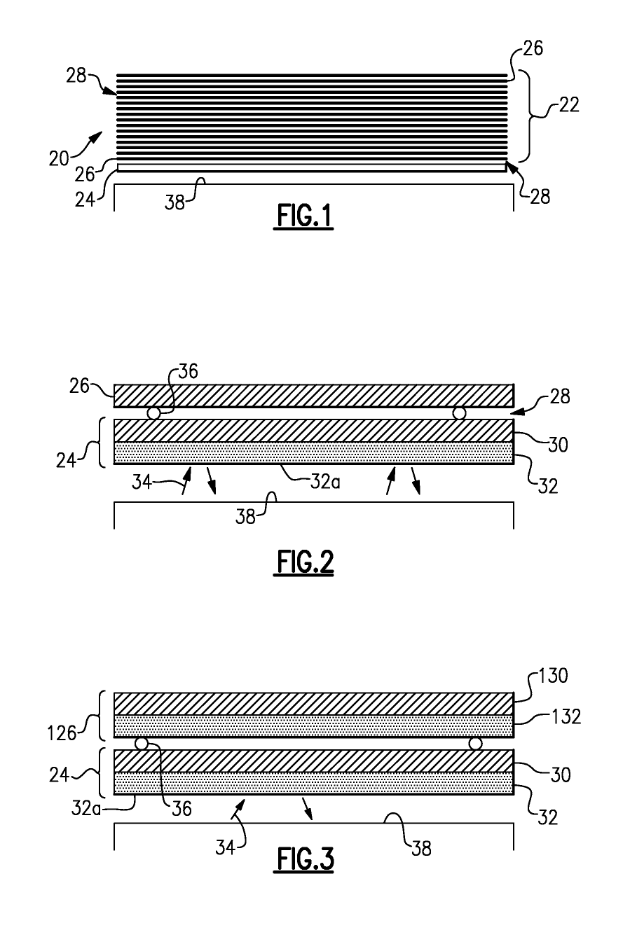

FIG. 1 shows selected portions of an example thermal insulator 20 that is useful in thermal systems to generate electricity, generate propulsion, control heating of a working fluid, or achieve another desired end use. In this regard, it is to be understood that the disclosed thermal insulator 20 may be used with other components that are not shown in the illustrations, such as heliostats, solar collectors, thermal storage units or the like that operate in conjunction with the thermal insulator 20 to achieve a desired end use purpose.

In the illustrated example, the thermal insulator 20 includes a plurality of insulation layers 22. In this example, the insulation layers 22 are substantially planar and are arranged in a stack. However, in other examples, the layers 22 are non-planar and are formed into a desired end-use shape, such as a contoured shape, hollow container or tube. In embodiments, such as for a solar receiver or a solar thermal propulsion device, the thermal insulator 20 includes from 50 to 100 of the insulation layers 22, but in other applications the thermal insulator 20 can include fewer or greater numbers of the layers 22.

The plurality of insulation layers 22 includes a first insulation layer 24 (lightly shaded in the drawing) and a second insulation layer 26 (darkly shaded in the drawing). The first insulation layer 24 is spaced apart from the second insulation layer 26 such that there is an open gap 28 between the layers 24 and 26. In one embodiment, the size of the gap 28 is equal to or less than the thickness of at least one of the insulation layers 22, which can be from approximately several micrometers to about one-half millimeter.

In the illustrated example, the first insulation layer 24 is the bottom-most layer in the arrangement and there are multiple second insulation layers 26 on top that are also spaced apart with open gaps 28. In other examples, the first insulation layer 24 can be a top-most layer or an intermediate layer anywhere in between. In further examples, the insulation layers 22 can also include multiple first insulation layers 24 in a desired arrangement with multiple second insulation layers 26, such as an alternating arrangement (one for one), periodic alternating arrangement (one for two or more), graded arrangement (increase/decrease in repetition of one layer through the stack) or block arrangement (blocks of similar layers).

FIG. 2 shows the first insulation layer 24 and the second insulation layer 26 from the thermal insulator 20 of FIG. 1, which may also be representative of other first insulation layers 24 and second insulation layers 26 in the thermal insulator 20. In this example, the first insulation layer 24 includes a substrate 30 and an infrared-reflective coating 32 that is disposed on the substrate 30. The infrared-reflective coating 32 is disposed directly on the surface of the substrate 30. In some examples, the first layer 24 can alternatively include other sub-layers in addition to the substrate 30 and the infrared-reflective coating 32, only the substrate 30 and the infrared-reflective coating 32 or only the infrared-reflective coating 32 (i.e., a monolithic infrared-reflective layer).

The infrared-reflective coating 32 functions to reflect a high percentage of the electromagnetic radiation in the infrared wavelength range (approximately 700 nanometers to 2500 nanometers). Thus, the infrared-reflective coating 32 forms an infrared-reflective surface 32a. The percentage of infrared radiation 34 that is reflected can vary, depending upon the composition of the infrared-reflective coating 32 and operating temperature, for example. In some examples, the percentage is approximately 30% to 50% at temperatures of 2000° F.-4000° F. (1090° C.-2200° C.).

Optionally, spacers 36 are arranged between the first insulation layer 24 and the second insulation layer 26. As an example, the spacers 36 are wires of low thermal conductivity material, such as tungsten or molybdenum. In embodiments, the spacers 36 are staggered with respect to the thickness direction through the stack such that there is no linear path of thermal conductivity.

In the illustrated example, the second insulation layer 26 is free of any infrared-reflective coating. The second insulation layer 26 includes only a single layer in one example, but alternatively can include multiple layers of the same or different materials. In one example, the composition of the second insulation layer 26 is metallic, such as a metallic foil or foils. In a further example, the second insulation layer 26 is selected from tungsten, molybdenum, a superalloy material or combinations thereof. Examples of the superalloy material include nickel-based or cobalt-based alloys.

In a further example, the substrate 30 is also metallic, such as a metallic foil. In one embodiment, the substrate 30 has the same composition as the second insulation layer 26. In another embodiment, the second insulation layer 26 and the substrate have different compositions selected from tungsten, molybdenum, a superalloy material or combinations thereof.

In one embodiment, the thermal insulator 20 includes a number N₁ of second insulation layers 26 that are free of any infrared-reflective coating and a number N₂ of first insulation layers 24 that have the infrared-reflective coating 32. In one example, a ratio R₁ of N₁:N₂ is from 1:1 to 4:1. For instance, the ratio R₁ represents an arrangement wherein the stack of insulation layers 22 includes multiple first insulation layers 24 periodically throughout the stack. In another example, a ratio R₂ of N₁:N₂ is from 20:1 to 50:1. For instance, the ratio R₂ represents an arrangement wherein the stack of insulation layers 22 includes one or relatively few of the first insulation layers 24, which are arranged on the side of the thermal insulator 20 that receives the infrared radiation 34.

The infrared-reflective coating 32 has a composition that is selected for a desired degree of infrared reflectivity and to meet the design requirements of the end use product with regard to operating temperature, processing, mechanical and other requirements. For solar receivers or other high temperature applications that can operate at temperature near or exceeding 4000° F./2200° C., the infrared-reflective coating 32 is a refractory member and includes a non-metallic and inorganic composition, although in some examples the infrared-reflective coating 32 can include metallic phases or regions.

In embodiments, the infrared-reflective coating 32 is or includes a boride, nitride or carbide of at least one refractory metal. The refractory metal or metals are selected from titanium, zirconium, hafnium, vanadium, niobium, tantalum, chromium, molybdenum, tungsten, rhenium, ruthenium, rhodium, osmium, iridium and combinations thereof. In some embodiments, the infrared-reflective coating 32 includes only the boride, nitride or carbide of the refractory metal or metals, to the exclusion of any other materials. In a further example, the infrared-reflective coating 32 is a boride, nitride or carbide of molybdenum, a boride, nitride or carbide of tungsten, or a combination thereof.

The combination of the first insulation layer 24, the second insulation layer 26 and the gap 28 cooperate to provide effective thermal insulation. In one example, the thermal insulator 20 is arranged near a radiant surface 38 (shown in part), such as near a heated conduit in a solar receiver, a nuclear material, a radiant energy source or the like, and operates to retain thermal energy. For instance, the gap 28 between the first insulation layer 24 and the second insulation layer 26 operates as a radiant heat insulator. In embodiments, the gap 28 is evacuated (to form a vacuum below atmospheric pressure) such that the evacuated space between the first insulation layer 24 and the second insulation layer 26 operates as a radiant heat barrier. Additionally, infrared radiation 34 from the radiant surface 38 impinges upon the infrared-reflective coating 32 and is reflected back toward the radiant surface 38. Thus, the combination of the open gap 28 and the infrared-reflective coating 32 facilitates the retention of thermal energy.

FIG. 3 illustrates another example that has a modified second insulation layer 126. In this disclosure, like reference numerals designate like elements where appropriate and reference numerals with the addition of one-hundred or multiples thereof designate modified elements that are understood to incorporate the same features and benefits of the corresponding elements. In this example, the second insulation layer 126 is equivalent to the first insulation layer 24 and includes a substrate 130 and an infrared-reflective coating 132. In embodiments, the substrates 30, 130 are of the same composition and the infrared-reflective coatings 32, 132 are of the same composition. In another example, the substrates 30, 130 have different compositions and the infrared-reflective coatings 32, 132 have the same composition. In another example, the substrates 30, 130 have the same composition and the infrared-reflective coatings 32, 132 have different compositions.

FIG. 4 illustrates a modified embodiment of a thermal insulator 120. In this example, the thermal insulator 120 also includes a plurality of insulation layers 22 but has multiple first insulation layers 24 that include the infrared-reflective coating 32 (not shown) on the side of the received infrared radiation 34. There are also multiple second insulation layers 26, which in this example do not include any infrared-reflective coatings.

FIG. 5 illustrates another modified embodiment of a thermal insulator 220. In this example, the thermal insulator 220 includes an alternating arrangement of multiple first insulation layers 24 that have the infrared-reflective coating 32 (not shown) and second insulation layers 26 that do not include any infrared-reflective coatings.

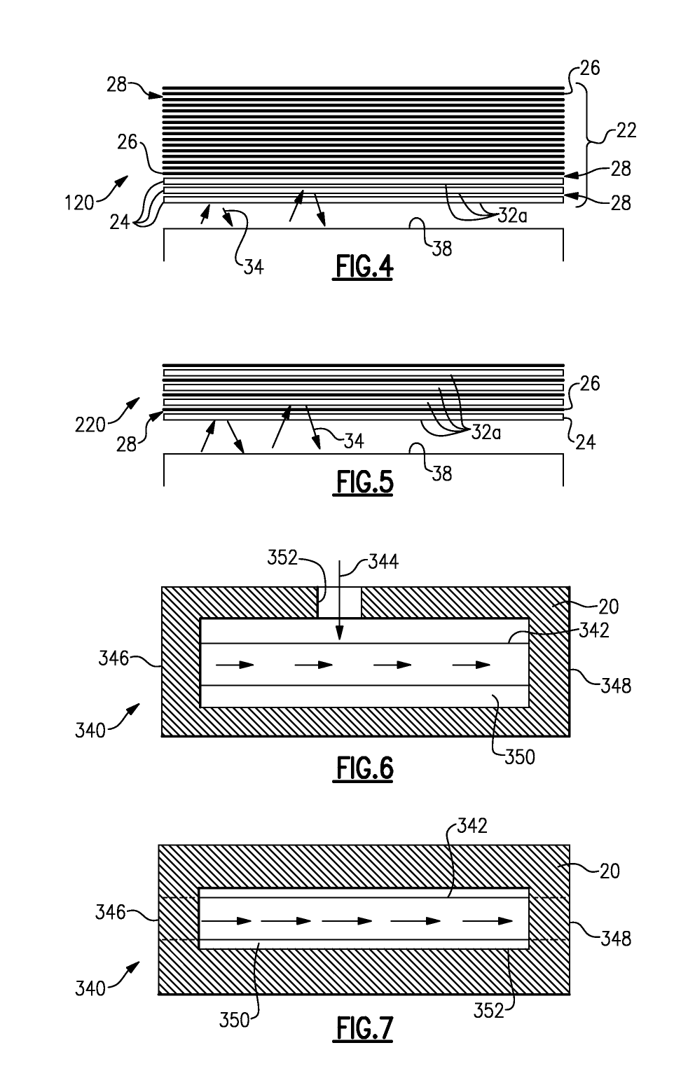

FIG. 6 shows an example solar receiver 340 in a cross-sectional view, and FIG. 7 shows the solar receiver 340 in a perspective view. In this example, the solar receiver 340 utilizes the thermal insulator 20, as described above. It is to be understood that the solar receiver 340 may alternatively utilize the thermal insulator 120 or 220.

In the illustrated example, the solar receiver 340 is generally cylindrical and includes a conduit 342 for receiving a working fluid to be heated by solar energy 344, which may be directed from a suitable solar concentrator. The conduit 342 extends between an inlet 346 for receiving the working fluid and an outlet 348 for discharging the working fluid.

The thermal insulator 20 is arranged around the periphery of the conduit 342. As shown in the example, there is an open gap 350 between the thermal insulator 20 and the periphery of the conduit 342, which may be evacuated to provide radiant heat insulation. Alternatively, the periphery of the conduit 342 is in direct contact with the thermal insulator 20 and there is no gap.

The thermal insulator 20 defines a window 352 for permitting the solar energy 344 to impinge upon the conduit 342 to heat the working fluid. In this example, the window 352 is generally elongated in a direction parallel to the long axis of the solar receiver 340. However, in other examples, the window 352 can have other shapes.

In operation, the working fluid enters through the inlet 346 of the conduit 342 and exits through an outlet 348. The solar energy 344 heats the conduit 342, which transfers the heat to the working fluid passing there through. In one embodiment, the working fluid is discharged through the outlet 348 to an appropriate storage unit, nozzle or other component. Thus, the exemplary solar receiver 340 may be used in solar power tower systems and the like as a heat transfer device for transferring thermal energy from the solar energy 344 to the working fluid. The thermal insulator 20 facilitates retention of the thermal energy within the solar receiver 340 for more efficient heating of the working fluid. As described above, the thermal insulator 20 provides radiant heat insulation via the gaps 28 and infrared-reflective coating or coatings 32 reflect infrared radiation emitted from radiant surfaces of the conduit 342 to reduce escape of infrared energy and thereby reduce thermal losses.

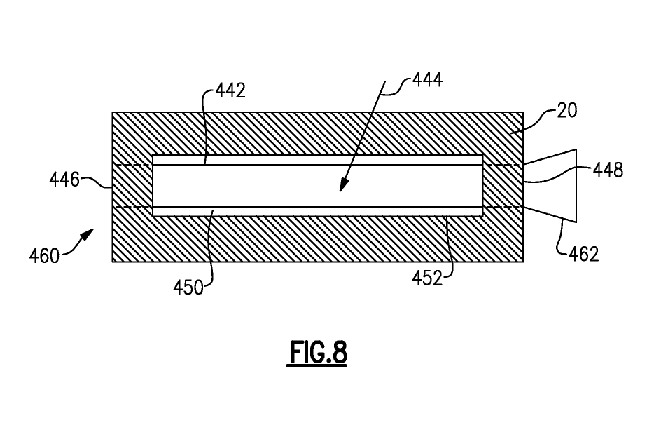

FIG. 8 shows an example solar thermal propulsion device 460 that also utilizes the thermal insulator 20. It is to be understood, however, that the solar thermal propulsion device 460 may alternatively utilize the thermal insulators 120 or 220. In this example, the solar thermal propulsion device 460 includes a conduit 442 having an inlet 446 for receiving a working fluid and an outlet 448 for discharging the working fluid. The thermal insulator 20 is arranged around the periphery of the conduit 442. Similar to the solar receiver 340, there may be an open gap 350 between the thermal insulator 20 and the periphery of the conduit 442. However, in other examples, there may be no gap and the thermal insulator 20 may be in direct contact with the periphery of the conduit 442. As described above, the thermal insulator 20 provides radiant heat insulation via the gaps 350 and infrared-reflective coating or coatings 32 reflect infrared radiation emitted from radiant surfaces of the conduit 442 to reduce escape of infrared energy and thereby reduce thermal losses.

In this example, the thermal insulator 20 defines a window 452 through which solar energy 444 is directed to impinge upon the conduit 442 and thereby heat the working fluid passing there through. A nozzle 462 is arranged to be in receiving communication with the outlet 448 to thereby receive the heated working fluid.

In operation, the solar energy 444 heats the working fluid passing through the conduit 442. The heated working fluid is discharged through the outlet 448 into the nozzle 462. Upon discharge, the heated working fluid expands in the nozzle 462 to thereby provide propulsion. The propellant or working fluid that is used is not limited to any particular kind and may be, for example, hydrogen, water, ammonia, or other monopropellant.

In some examples, the thermal insulator 20, 120, 220 is fabricated by arranging sheets of each of the layers 22 in the desired arrangement with respect to the order and spacing of the layers 22. If the thermal insulator 20, 120, 220 is contoured, the sheets can be stacked around a suitably mandrel to form the desired contour. The individual sheets are relatively thin (e.g., foil) and can be conformed to the contour of the mandrel. In further examples, if the thermal insulator 20, 120, 220 is to be used in the solar receiver 340 or solar thermal propulsion device 460, the sheets can be wrapped around a cylindrical mandrel to provide a tubular shape. For sheets that include the infrared-reflective coating 32, the infrared-reflective coating 32 is pre-deposited onto the substrate 30, 130 using a suitable deposition technique, such as thermal spraying, physical vapor deposition, slurry coating, or other known coating technique. Alternatively, the infrared reflective coating 32 or layer is a foil, a blanket, a cover, a shell, an enclosure or the like with regard to a radiant heat source.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. An insulator comprising:
a refractory member including a non-metallic, infrared-reflective surface;
a radiant surface adjacent the refractory member; and
a vacuum between the radiant surface and the refractory member.

2. A thermal insulator comprising:
a plurality of insulation layers including a first insulation layer spaced apart from a second insulation layer such that there is an open gap there between, at least one of the first insulation layer or the second insulation layer including a substrate and an infrared-reflective coating on the substrate.

3. The thermal insulator as recited in claim 2, wherein the substrate is metallic.

4. The thermal insulator as recited in claim 3, wherein the substrate is selected from a group consisting of tungsten, molybdenum, superalloy material and combinations thereof.

5. The thermal insulator as recited in claim 2, wherein the infrared-reflective coating includes at least one of a boride, a nitride or a carbide of a refractory metal.

6. The thermal insulator as recited in claim 5, wherein the refractory metal includes molybdenum.

7. The thermal insulator as recited in claim 5, wherein the refractory metal includes tungsten.

8. The thermal insulator as recited in claim 2, wherein the plurality of insulation layers include at least one insulation layer that is free of any infrared-reflective coating and that is spaced apart from a neighboring insulation layer that has an infrared-reflective coating.

9. The thermal insulator as recited in claim 8, wherein the at least one insulation layer that is free of the infrared-reflective coating is selected from a group consisting of tungsten, molybdenum, a superalloy material and combinations thereof.

10. The thermal insulator as recited in claim 2, including a spacer between the first insulation layer and the second insulation layer establishing the open gap there between.

11. The thermal insulator as recited in claim 2, wherein the plurality of insulation layers includes an alternating arrangement of insulation layers having the substrate and the infrared-reflective coating and insulation layers that are free of any infrared-reflective coating.

12. The thermal insulator as recited in claim 2, wherein the plurality of insulation layers define a window.

13. The thermal insulator as recited in claim 2, wherein the plurality of insulation layers include from 50 to 100 insulation layers.

14. The thermal insulator as recited in claim 2, wherein the plurality of insulation layers includes a number N₁ of insulation layers that are free of any infrared-reflective coating and a number N₂ of insulation layers that have an infrared-reflective coating, and a ratio N₁:N₂ is from 1:1 to 4:1.

15. The thermal insulator as recited in claim 2, wherein the plurality of insulation layers includes a number N₁ of insulation layers that are free of any infrared-reflective coating and a number N₂ of insulation layers that have an infrared-reflective coating, and a ratio N₁:N₂ is from 20:1 to 50:1.

16. A solar receiver comprising:
a conduit for receiving a working fluid to be heated by solar energy; and
a thermal insulator arranged around the periphery of the conduit, the thermal insulator comprising a plurality of insulation layers including a first insulation layer spaced apart from a second insulation layer such that there is an open gap there between, at least one of the first insulation layer or the second insulation layer including a substrate and an infrared-reflective coating on the substrate.

17. The solar receiver as recited in claim 16, wherein the thermal insulator defines a window permitting the solar energy to impinge upon the conduit.

18. The solar receiver as recited in claim 16, wherein the substrate is selected from a group consisting of tungsten, molybdenum, a superalloy material and combinations thereof.

19. The solar receiver as recited in claim 16, wherein the infrared-reflective coating includes at least one of a boride, a nitride or a carbide of a refractory metal.

20. A solar thermal propulsion device comprising:
a conduit having an inlet for receiving a working fluid and an outlet for discharging the working fluid;
a window adjacent the conduit for permitting solar energy to impinge upon the conduit to heat the working fluid;
a nozzle in receiving communication with the outlet; and
a thermal insulator arranged around the periphery of the conduit, the thermal insulator comprising a plurality of insulation layers including a first insulation layer spaced apart from a second insulation layer such that there is an open gap there between, at least one of the first insulation layer or the second insulation layer including a substrate and an infrared-reflective coating on the substrate.

21. The solar thermal propulsion device as recited in claim 20, wherein the substrate is selected from a group consisting of tungsten, molybdenum, a superalloy material and combinations thereof.

22. The solar thermal propulsion device as recited in claim 20, wherein the infrared-reflective coating includes at least one of a boride, a nitride or a carbide of a refractory metal.
